(19) United States
(12) Patent Application Publication
(10) Pub. No.: US 2012/0027193 A1
(43) Pub. Date: Feb. 2, 2012

(54) APPARATUS AND METHOD FOR CREATING CALL TRANSMISSION SCREEN USING COLLAGE TECHNIQUE

(75) Inventors: Chang-Han KIM, Seoul (KR); Joo-Young Son, Suwon-si (KR); Tae-Hwa Hong, Seoul (KR); Sung-Dae Cho, Yongin-si (KR)

(73) Assignee: Samsung Electronics Co., Ltd., Gyeonggi-do (KR)

(21) Appl. No.: 13/193,217

(22) Filed: Jul. 28, 2011

(30) Foreign Application Priority Data
Jul. 30, 2010 (KR) 10-2010-0074281

(51) Int. Cl. H04M 3/44

(52) U.S. Cl. 379/216.01

(57) ABSTRACT

An apparatus and method for creating a call transmission screen using a collage technique is provided. The method includes analyzing user condition information, calculating priorities for terminal transmission/reception information corresponding to the analyzed user condition information according to predetermined priority conditions, selecting available transmission/reception information, used to create a call transmission screen, from the prioritized terminal transmission/reception information, and creating the call transmission screen using the collage technique by arranging images corresponding to the available transmission/reception information according to a predetermined pattern.

### PRIORITY

This application claims priority under 35 U.S.C. §119(a) to a Korean Patent Application filed in the Korean Intellectual Property Office on Jul. 30, 2010 and assigned Serial No. 10-2010-0074281, the entire disclosure of which is incorporated herein by reference.

### BACKGROUND OF THE INVENTION

1. Field of the Invention

The present invention relates generally to an apparatus and method for creating a call transmission screen, and, more particularly, to an apparatus and method for creating a call transmission screen using a collage technique.

2. Description of the Related Art

Generally, a terminal provides a user with a plurality of phone numbers registered in a phone book for call transmission, and performs call transmission for the phone number selected by the user. Moreover, the terminal provides the user with a plurality of phone numbers corresponding to a transmission/reception history registered in time order, and performs call transmission for the phone number selected by the user.

However, according to the above call transmission methods, the user is inconvenienced by having to search for a desired phone number from the phone numbers provided.

In order to solve the above problem, functions have been implemented for enabling a user to manually register information about a person in an idle screen to perform a direct call function, or a function for displaying a figure image (or a portrait image) on a terminal screen and performing a direct call function when the displayed figure image is selected by the user.

As described above, in a first conventional method, the user manually registers information about a person in an idle screen to perform a direct call transmission. In a second conventional method, a figure image is displayed on the terminal screen and a direct call transmission is performed when the displayed figure image is selected by the user.

However, according to the first conventional method, the user is inconvenienced by having to manually register figure information (portrait information) in the terminal screen for call transmission.

Moreover, according to the second conventional method, since a call list is managed on the basis of figure images, a desired figure image may fail to be registered in the phone book, or an image of an unregistered phone number cannot be displayed on the terminal screen.

### SUMMARY OF THE INVENTION

An aspect of the present invention provides an apparatus and method for generating a collage image for call transmission by a collage technique and displaying the generated collage image on a screen.

According to an aspect of the present invention, an apparatus for creating a call transmission screen using a collage technique is provided, including a user condition-analyzing unit for analyzing user condition information; a priority-calculating unit for calculating priorities according to predetermined priority conditions; an available transmission/reception information-selecting unit for selecting available transmission/reception information used to create a call transmission screen; a call transmission screen-creating unit for arranging a plurality of images according to a predetermined pattern to create a call transmission screen using a collage technique; and a control unit for controlling the priority-calculating unit to calculate priorities for terminal transmission/reception information corresponding to the user condition information analyzed by the user condition-analyzing unit, commanding the available transmission/reception information-selecting unit to select the available transmission/reception information from the prioritized terminal transmission/reception information, and commanding the call transmission screen-creating unit to create the call transmission screen using the image corresponding to the selected available transmission/reception information.

According to another aspect of the present invention, a method for creating a call transmission screen using a collage technique is provided, including analyzing user condition information; calculating priorities for terminal transmission/reception information corresponding to the analyzed user condition information according to predetermined priority conditions; selecting available transmission/reception information, used to create a call transmission screen, from the prioritized terminal transmission/reception information; and creating the call transmission screen using the collage technique by arranging images corresponding to the available transmission/reception information according to a predetermined pattern.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is a block diagram illustrating a terminal according to an embodiment of the present invention;

FIG. 2 is a diagram illustrating an example of a transmission/reception list arranged according to priority conditions according to an embodiment of the present invention;

FIG. 3 is a flow diagram illustrating a process for creating a call transmission screen in a terminal according to an embodiment of the present invention;

FIG. 4 is a flow diagram illustrating a process for selecting and reading an image corresponding to an available phone number from a memory unit according to an embodiment of the present invention;

FIG. 5 is a diagram illustrating an example of a collage image arrangement pattern according to an embodiment of the present invention;

FIG. 6 is a diagram illustrating an example of a collage image generated according to an embodiment of the present invention; and

FIG. 7 is a diagram illustrating an example of a setting screen overlaid on a collage image generated according to an embodiment of the present invention.

### DETAILED DESCRIPTION OF EMBODIMENTS

Embodiments of the present invention will be described below in detail with reference to the accompanying drawings. Like reference numerals in the drawings denote like elements. In the following description, detailed descriptions of well-known functions or configurations will be omitted since they would unnecessarily obscure the subject matters of the present invention.

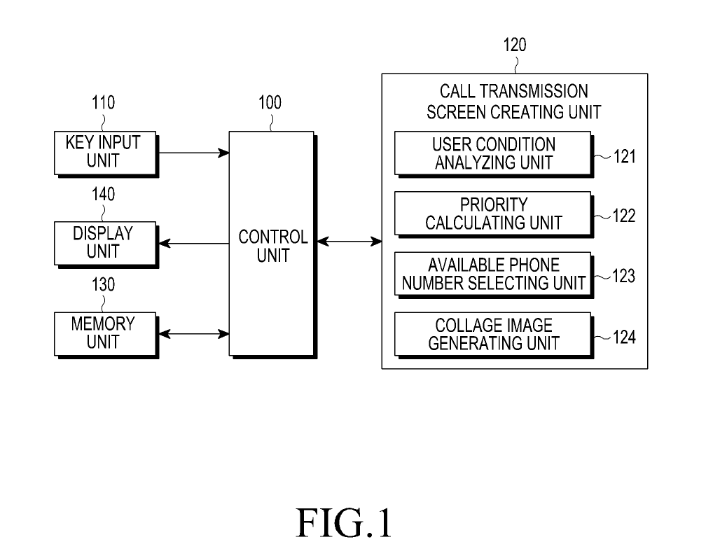

FIG. 1 is a block diagram of a terminal according to an embodiment of the present invention.

Referring to FIG. 1, a terminal according to an embodiment of the present invention includes a control unit 100, a key input unit 110, a call transmission screen-creating unit 130, and a display unit 140.

The key input unit 110 includes a key for inputting a call transmission screen creation request, and a key for inputting a call transmission screen display request. The key input unit 110 may further include a key for inputting user settings to create a call transmission screen.

The call transmission screen-creating unit 120 creates a call transmission screen under the control of the control unit 100. The call transmission screen-creating unit 120 includes a user condition-analyzing unit 121, a priority-calculating unit 122, an available phone number-selecting unit 123, and a collage image-generating unit 124.

The user condition-analyzing unit 121 analyzes user condition information such as the current date and time, and a position of the terminal. For example, if the terminal has a Global Positioning System (GPS) receiver, the user condition-analyzing unit 121 may use a GPS position sensor to detect the current position of the user.

The priority-calculating unit 122 analyzes priority conditions such as a transmission/reception frequency and a call time about transmission/reception information such as a name or a phone number corresponding to the user condition information, analyzed by the user condition-analyzing unit 121, from the transmission/reception list of the terminal and calculates priorities.

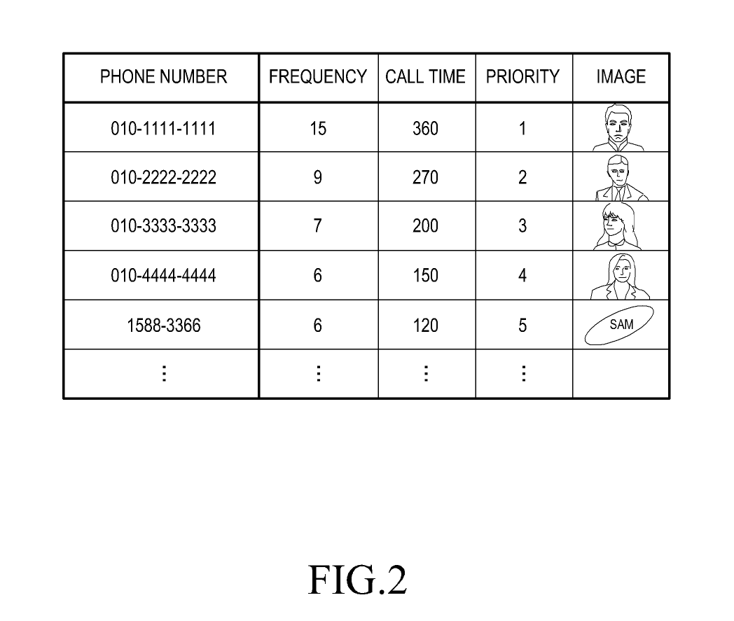

For example, if the current position of the terminal is detected through the GPS receiver of the terminal, the priority-calculating unit 122 analyzes priority conditions such as a transmission/reception frequency and a call time about each of phone numbers corresponding to a transmission/reception list such as voice calls, video calls, and text messages transmitted/received at the detected position, calculates priorities, and arranges the phone numbers of the transmission/reception list in descending order of priority. FIG. 2 illustrates an example of the transmission/reception list arranged as described above. The priority-calculating unit 122 may calculate the priorities by analyzing only the transmission/reception frequency or by analyzing the call time along with the transmission/reception frequency.

In the present invention, priority conditions such as a transmission/reception frequency and a call time are analyzed to calculate the priorities. In another embodiment of the present invention, priority conditions are input from the user and the input user priority conditions are also analyzed to calculate the priorities.

For example, when a request for calculation of priorities of persons corresponding to a friend group of the phone book is input through the key input unit 110, the priority-calculating unit 122 may calculate the priorities by analyzing a transmission/reception frequency and a call time about each of the phone numbers corresponding to the friend group.

The available phone number-selecting unit 123 selects an available phone number, used to generate a collage image for call transmission, from the transmission/reception list arranged according to the calculated priorities. The available phone number-selecting unit 123 may select a predetermined number of available phone numbers from the transmission/reception list in descending order of the priorities. Also, the available phone number-selecting unit 123 may exclude a phone number starting with a specific number such as a spam number from the selection as an available phone number.

The collage image-generating unit 124 reads an image corresponding to the selected available phone number from the memory unit 130, and generates a collage image according to the priorities by using the image corresponding to the selected available phone number.

Specifically, when generating the collage image, the collage image-generating unit 124 determines whether the available phone number is a phone number registered in the phone book of the terminal. If the available phone number is the phone number registered in the phone book, the collage image-generating unit 124 selects a figure image corresponding to the registered phone number. If the available phone number is the registered phone number and if there is no figure image corresponding to the registered phone number, the collage image-generating unit 124 analyzes the gender of a name corresponding to the registered phone number and selects a replacement image such as an avatar image corresponding to the analyzed gender.

Also, if the available phone number is not the registered phone number, the collage image-generating unit 124 compares the available phone number with a prestored company phone number. If the available phone number is a company phone number, the collage image-generating unit 124 selects a company logo image corresponding to the company phone number.

If the available phone number is not the registered phone number and is not the company phone number, the collage image-generating unit 124 selects other image such as a prestored text image.

In an embodiment, the available phone number-selecting unit 123 may exclude a phone number starting with a specific number such as a spam number from the selection as an available phone number. In another embodiment, the collage image-generating unit 124 may exclude a phone number from the selection as an available phone number if the phone number is not the registered phone number and is not the prestored company phone number.

The memory unit 130 stores various updatable data, reference data, and programs to process and control of the control unit 100. The memory unit 130 is provided as a working memory of the control unit 100.

The memory unit 130 stores a phone book containing user information such as names, phone numbers, addresses, and figure images; and replacement images replacing user images, such as avatar images, character images, and icon images.

Also, the memory unit 130 may store company-related images such as logo, icon and character images related to companies, and the company-related images may be received from a separate company server.

The display unit 140 displays a created call transmission screen. The display unit 140 may also display a screen for inputting user settings used to create a call transmission screen. Also, the display unit 140 may include a touchpad to receive a touch input.

The control unit 100 commands the call transmission screen-creating unit 120 to create a call transmission screen when a call transmission screen creation request is input from the key input unit 110.

Specifically, the control unit 100 commands the user condition-analyzing unit 121 to analyze user condition information of the terminal, and commands the priority-calculating unit 122 to analyze priority conditions for transmission/reception information, registered in a transmission/reception list of the terminal, with reference to the user condition information and calculate priorities.

The control unit 100 commands the available phone number-selecting unit 123 to select an available phone number, used to create a collage image for call transmission, from the transmission/reception list arranged according to the calculated priorities.

The control unit 100 then commands the collage image-generating unit 124 to generate a collage image according to the priorities by using an image corresponding to the selected available phone number.

As described above, the present invention calculates the priorities for the transmission/reception list of the terminal and creates a call transmission screen according to the calculated priorities by using the image corresponding to the selected available phone number, thereby making it possible to provide a more quick calling function to the user.

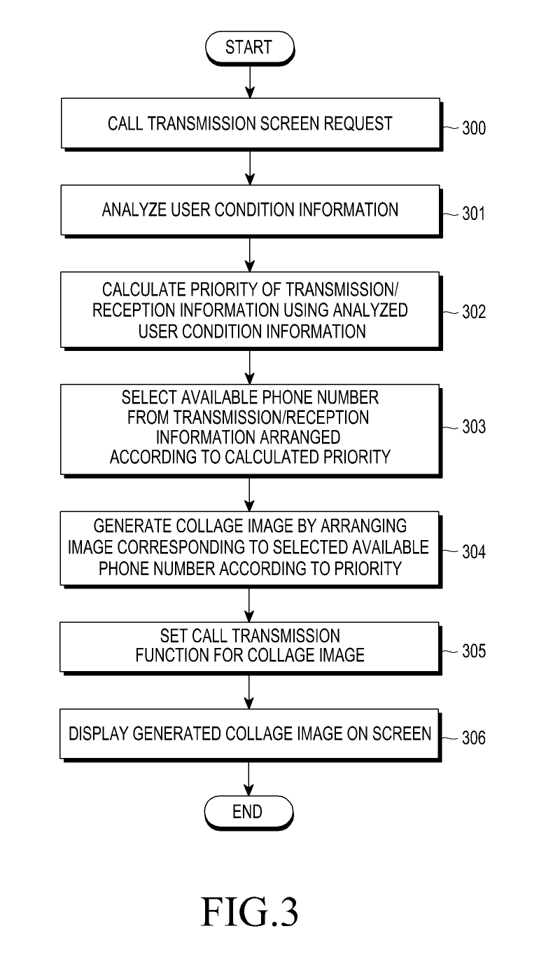

FIG. 3 is a flow diagram illustrating a process for creating a call transmission screen in the terminal according to an embodiment of the present invention.

Referring to FIG. 3, in step 300, the control unit 100 receives a call transmission screen creation request from the key input unit 110.

In step 301, the control unit 100 commands the user condition-analyzing unit 121 to analyze user condition information such as the current date and time, and a position of the terminal.

In step 302, the control unit 100 commands the priority-calculating unit 122 to analyze priority conditions for terminal transmission/reception information corresponding to the analyzed user condition information from the transmission/reception list of the terminal and calculate priorities.

In step 303, the control unit 100 commands the available phone number-selecting unit 123 to select an available phone number, used to create a collage image for a call transmission screen, from the transmission/reception information arranged according to the calculated priorities.

In step 304, the control unit 100 commands the collage image-generating unit 124 to read an image corresponding to the selected available phone number from the memory unit 140, arrange the read image on the screen according to the priorities and generate a collage image.

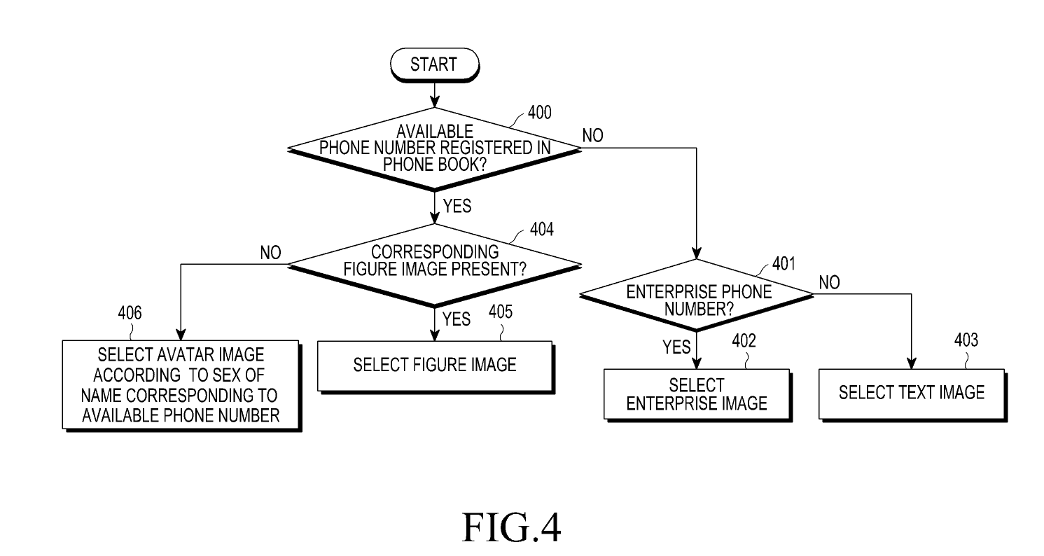

A process for selecting and reading, by the control unit 100, an image corresponding to an available phone number from the memory unit 140 will be described below in detail with reference to FIG. 4.

FIG. 4 is a flow diagram illustrating a process for selecting and reading an image corresponding to an available phone number from the memory unit 140, according to an embodiment of the present invention.

Referring to FIG. 4, in step 400, the control unit 100 determines whether the available phone number is a phone number registered in the phone book. If the available phone number is registered in the phone book, the control unit 100 proceeds to step 404; and if not, the control unit 100 proceeds to step 401. In step 401, the control unit 100 compares the available phone number with a company phone number stored in the memory unit 140 and determines whether the available phone number is a company phone number.

If the available phone number is a company phone number, the control unit 100 proceeds to step 402; and if not, the control unit 100 proceeds to step 403. In step 402, the control unit 100 selects a company logo image.

In step 403, the control unit 100 selects other image such as a text image comprised of a plurality of font styles. If the available phone number is not a company phone number, the control unit 100 may exclude the available phone number from being selected as a phone number used to create a collage image. In this manner, an unnecessary phone number such as a spam number is filtered, thereby enabling the user to perform quick call transmission for available phone numbers.

In step 404, the control unit 100 determines whether an image corresponding to the available phone number is present in the memory unit 130. If an image corresponding to the available phone number is present in the memory unit 130, the control unit 100 proceeds to step 405; and, if not, the control unit 100 proceeds to step 406. In step 405, the control unit 100 selects a figure image corresponding to the available phone number.

In step 406, the control unit 100 analyzes the gender of a name corresponding to the available phone number and selects a replacement image such as an avatar or character image corresponding to the analyzed gender. The selected image is defined as an image component used to generate a collage image.

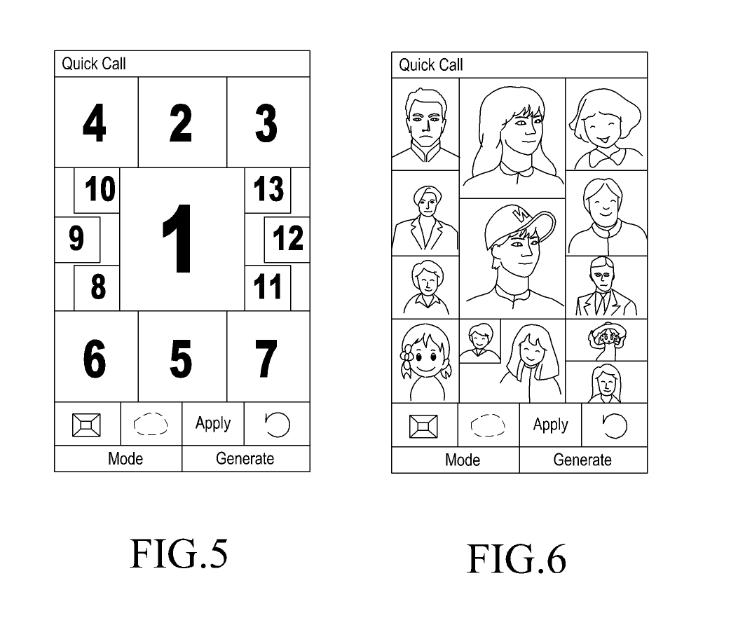

In step 304, the control unit 100 generates a collage image using image components selected corresponding to the available phone number. This will be described below in detail with reference to FIGS. 5 and 6.

As illustrated in FIG. 5, the control unit 100 reads an arrangement pattern of a collage image, in which the positions and sizes of pattern components on the collage image are set according to the priorities, from the memory unit 130. The number of pattern components in the arrangement pattern is equal to the number of the selected image components. The arrangement pattern may be provided by presetting the positions and sizes of the pattern components by the user, or may be provided by setting the preset positions and sizes of the pattern components randomly.

Also, the control unit 100 may match an image component, corresponding to an available phone number with a high priority, to the position of a pattern component that is the easiest of access by the user. For example, an image component corresponding to the first priority 1 may be matched to the position of a pattern component corresponding to an identification number 500 as illustrated in FIG. 5.

In step 305, the control unit 100 sets a call transmission function for each image component of the generated collage image.

Specifically, the control unit 100 sets a quick call transmission function for performing call transmission by an available phone number corresponding to each of the image components on the generated collage image. For example, if the display unit 140 is a touchpad, and when there is a touch input of approximately 4 to 5 seconds corresponding to each of the image components on the generated collage image, the control unit 100 may set a quick call transmission function for performing call transmission by an available phone number corresponding to each of the image components.

Accordingly, when there is a touch input of a predetermined time corresponding to an image component, the control unit 100 may perform call transmission by an available phone number corresponding to the touch-input image component.

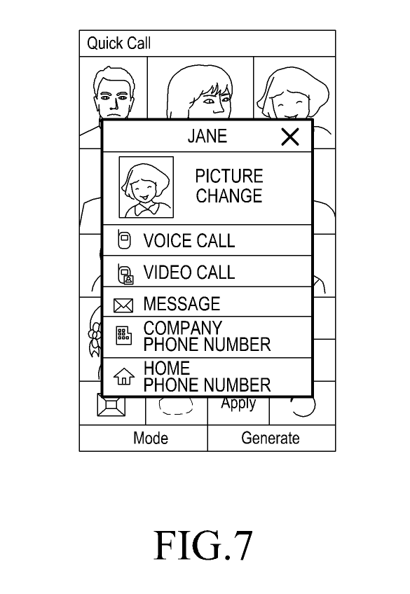

When there is a touch input of about 1 to 2 seconds corresponding to each of the image components on the collage image, the control unit 100 may overlay the collage image with a setting screen containing user information such as a home phone number, a business phone number and a figure picture corresponding to each of the image components and icons for performing a voice call function, a video call function and a message transmission function, as illustrated in FIG. 7. Accordingly, the user can change user information such as figure images and phone numbers registered in the phone book, and can perform not only a voice call function, but also a voice call function and a message transmission function.

In step 306, the control unit 100 commands the display unit 140 to display the generated collage image. FIG. 6 illustrates an example of the displayed collage image. As illustrated in FIG. 6, a plurality of image components of the collage image may partially overlap with each other, and the boundary between the image components may be blended.

As described above, the present invention selects available phone numbers according to user conditions and priority conditions, generates a collage image using images corresponding to the selected available phone numbers, sets a call transmission function for the generated collage image, and displays the same on an idle screen, thereby enabling the user to perform quick and easy call transmission and use an efficient idle screen.

While the invention has been shown and described with reference to embodiments thereof, it will be understood by those skilled in the art that various changes in form and details may be made therein without departing from the spirit and scope of the invention as defined by the appended claims and their equivalents.

What is claimed is:

1. An apparatus for creating a call transmission screen using a collage technique, the apparatus comprising:
a user condition-analyzing unit for analyzing user condition information;
a priority-calculating unit for calculating priorities according to predetermined priority conditions;
an available transmission/reception information-selecting unit for selecting available transmission/reception information used to create a call transmission screen;
a call transmission screen-creating unit for arranging a plurality of images according to a predetermined pattern to create a call transmission screen using a collage technique; and
a control unit for controlling the priority-calculating unit to calculate priorities for terminal transmission/reception information corresponding to the user condition information analyzed by the user condition-analyzing unit, controlling the available transmission/reception information-selecting unit to select the available transmission/reception information from the prioritized terminal transmission/reception information, and controlling the call transmission screen-creating unit to create the call transmission screen using the image corresponding to the selected available transmission/reception information.

2. The apparatus of claim 1, wherein the user condition information includes a current date and time, and position of a user.

3. The apparatus of claim 1, wherein the priority conditions include a transmission/reception frequency and a call time.

4. The apparatus of claim 3, wherein the priority-calculating unit arranges the terminal transmission/reception information in descending order of the priorities.

5. The apparatus of claim 1, further comprising:
a memory unit for storing a figure image corresponding to user transmission/reception information and a replacement image replacing the figure image,
wherein, if there is the user transmission/reception information identical to the available transmission/reception information, the control unit determines whether there is user transmission/reception information identical to the available transmission/reception information, and creates the call transmission screen using the figure image corresponding to the user transmission/reception information.

6. The apparatus of claim 5, wherein if there is no user transmission/reception information identical to the available transmission/reception information, the control unit reads the replacement image corresponding to the user transmission/reception information and creates the call transmission screen using the read replacement image.

7. The apparatus of claim 1, wherein the control unit sets a call transmission function for each of the images based on the available transmission/reception information corresponding to the images arranged in the generated collage image.

8. A method for creating a call transmission screen using a collage technique, the method comprising:
analyzing user condition information;
calculating priorities for terminal transmission/reception information corresponding to the analyzed user condition information according to predetermined priority conditions;
selecting available transmission/reception information, used to create a call transmission screen, from the prioritized terminal transmission/reception information; and
creating the call transmission screen using the collage technique by arranging images corresponding to the available transmission/reception information according to a predetermined pattern.

9. The method of claim 8, wherein the user condition information includes a current date and time, and a position of a user.

10. The method of claim 8, wherein the priority conditions include a transmission/reception frequency and a call time.

11. The method of claim 10, wherein calculating the priorities comprises:
arranging the terminal transmission/reception information in descending order of the priorities.

12. The method of claim 8, wherein creating the call transmission screen comprises:
determining whether there is user transmission/reception information identical to the available transmission/reception information; and
if there is the user transmission/reception information identical to the available transmission/reception information, creating the call transmission screen using a figure image corresponding to the user transmission/reception information.

13. The method of claim 12, wherein creating the call transmission screen comprises:
if there is no user transmission/reception information identical to the available transmission/reception information, reading a replacement image corresponding to the user transmission/reception information; and
creating the call transmission screen using the read replacement image.

14. The method of claim 8, further comprising:
setting a call transmission function for each of the images based on the available transmission/reception information corresponding to the images arranged in the generated call transmission screen.
